(19) United States
(12) Patent Application Publication
(10) Pub. No.: US 2003/0098811 A1
(43) Pub. Date: May 29, 2003

(54) Method of determining the position of a mobile station on the basis of propagation models

(75) Inventors: Dirk Nikolai, Stuttgart (DE); Bernd-Ludwig Wenning, Bremen (DE)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/299,694

(22) Filed: Nov. 20, 2002

(30) Foreign Application Priority Data
Nov. 27, 2001 (DE) 101 57 941.1

(51) Int. Cl. G01S 3/02

(52) U.S. Cl. 342/458; 342/464

(57) ABSTRACT

In a method of estimating the position of a mobile station (2) in a mobile radio network (1) on the basis of propagation models, at the mobile station (2) the field strength of a plurality of base stations (6-8) connected to the mobile station (2) is measured, the distance between the mobile station (2) and each of the base stations (6-8) connected to the mobile station (2) is estimated on the basis of a propagation model, and the estimated distances are stored, the estimated distances being filtered and the position of the mobile station (2) being estimated on the basis of the filtered estimated distances. In a further development the propagation model used can be adapted on the basis of the measured field strengths. In this way a more accurate position determination of the mobile station (2) can be effected.

### BACKGROUND OF THE INVENTION

The invention relates to a method of determining the position of a mobile station on the basis of propagation models, wherein at the mobile station the field strength of a plurality of base stations connected to the mobile station is measured, the distance between the mobile station and each of the base stations connected to the mobile station is estimated on the basis of a propagation model, and the estimated distances are stored.

The invention is based on a priority application DE 101 57 941.1 which is hereby incorporated by reference.

### SUMMARY OF THE INVENTION

The position of a mobile station of a mobile radio network, and thus the current location of the user of the mobile station, can be determined by means of different standardized methods, such as for example cell identity, delay time measurement, GPS-support etc. Different degrees of accuracy of the position determination can be fundamentally achieved with the different methods. The degrees of accuracy can depend upon suitable pre- or post-processing of the determined values and upon the current radio channel situation.

If the position is determined on the basis of field strength measurements, the field strength of a radio signal emitted from a base station is measured at the mobile station. The field strengths, measured at a mobile station, of up to seven base stations in the case of the GSM system are combined in a so-called measurement report in each mobile station and forwarded to the base station. The measurement report is continuously updated and when required is forwarded from the base station to a location centre for mobile stations (mobile location centre MLC). The distance d of the mobile station from the individual base stations is estimated using radio propagation models. The current location of the mobile station is estimated as the position which corresponds most closely to the estimated distances.

The Hata model can be mentioned as an example of a known propagation module. In accordance with the Hata model, the distance d can be estimated from the following equation:

D=A+B (log(d/km))

where D is the (propagation) attenuation calculated from measured received power and known transmitted power. For the distance estimation, average values are predefined for the fundamental attenuation A and the propagation coefficient B of the electromagnetic waves, which can be different for each cell surrounding a base station or each cell sector. Average values for the fundamental attenuation A and propagation coefficient B are known to the mobile radio network operators from the cell planning.

The instantaneous attenuation is dependent upon a number of limiting conditions, such as for example near-field- or far-field region, local development, weather, whether the mobile station is located in a building or a vehicle, or whether it is in the open. In particular, the high additional fundamental attenuation inside buildings or inside vehicles can lead to errors in the distance estimation.

The object of the present invention is therefore to develop a method based on field strength measurement, with which the accuracy of the position determination can be increased.

This object is achieved, in accordance with the invention, by a method of determining the position of a mobile station in a mobile radio network on the basis of propagation models, wherein at the mobile station the field strength of a plurality of base stations connected to the mobile station is measured, the distance between the mobile station and each of the base stations connected to the mobile stations is estimated on the basis of a propagation model and the estimated distances are stored, the estimated distances are filtered, and the position of the mobile station is estimated on the basis of the filtered estimated distances.

Due to the filtering of the estimated distances, less consideration is given to unrealistic estimated distances for the position determination. This can distinctly reduce the error in the position determination as a result of attenuations which differ from the average value, for example upon the occurrence of temporary, strong fading effects.

In an advantageous method variant, the estimated distances are filtered such that for each mobile station-base station connection, firstly the difference between the current estimated distance and the last estimated distance is determined, a reliable maximum difference is defined, and the position determination is effected using current estimated distances for which the difference is smaller than or equal to the maximum difference. As a result of this measure, the currently estimated distance is compared with the last estimated distance and it can be assessed whether the currently estimated distance is realistic.

In an alternative method variant, the estimated distances are filtered such that for each mobile station-base station connection, the estimated distances from a plurality of preceding measurements are averaged, the difference between the currently estimated distance and the averaged estimated distance is determined, a maximum difference is defined and the position determination is effected using current estimated distances for which the difference is smaller than or equal to the maximum difference. Due to the averaging of the preceding estimated distances, preceding mis-estimations are of less consequence or are compensated. By comparing the currently estimated distance with the average value of the preceding estimated distances it is therefore possible to make a reliable pronouncement on the accuracy of the currently estimated distance.

In a further development of the method, the estimated distances of preceding measurements are temporally weighted. In this way, for example, greater consideration can be given to more recent estimated distances than to earlier estimated distances. Thus a temporal filtering of the estimated distances takes place. Alternatively or additionally however, it can be provided that the estimated positions of the mobile station are temporally filtered.

Another method variant consists of correcting an estimated position which lies outside a current cell by transposing the estimated position into the region of the cell. A cell is defined by the radio coverage area of a base station. For example it can be provided that the position of the mobile station is placed at the edge of the radio coverage area. However this assumes that the spatial dimensions of the cell in which the mobile station is currently located are known.

In a particularly advantageous method variant, the differences between the filtered estimated distances and the estimated position are determined and the fundamental attenuation in the propagation model is adapted on the basis of these differences. It is then possible to re-estimate the position of the mobile station with the adapted fundamental attenuation. This process can be repeated (iteration). “Difference” is to be understood as the shortest interval between the estimated position of the mobile station and an estimated distance. Thus the propagation model being used can be adapted on the basis of the measured field strengths. The accuracy of the position estimation of the mobile station can thereby be considerably improved compared to estimations on the basis of rigid propagation models. It will be obvious that a particularly good adaptation of the propagation model can be achieved if filtered estimated distances are used for the position determination. However it is also conceivable to estimate the position with unfiltered estimated distances and to determine the difference between these distances and the estimated position. The method can also be used to differentiate between mobile stations and users located in the open, in a vehicle or in a building. With the adapted fundamental attenuation it is also possible to accurately determine the position for mobile stations located in buildings.

In a further development, the fundamental attenuation is self-adapted. In this way an even better and faster adaptation of the fundamental attenuation can be achieved, so that the position of the mobile station can always be determined as accurately as possible.

In an advantageous development of the method according to the invention, the distances between the mobile station and the respective base stations are estimated using different values for the fundamental attenuation of the propagation model and the position of the mobile station is determined and stored for each value of the fundamental attenuation. For each value of the fundamental attenuation, the differences between the estimated positions and the estimated distances are determined. The position which was determined using the smallest sum of the differences is selected. The estimated distances can be filtered. The filtering can for example consist of averaging the preceding estimated distances between the mobile station and a base station for a specified value of the fundamental attenuation. The position of the mobile station can be accurately determined as a result of this procedure, as the position determination is based on the distances which were estimated using a value of the fundamental attenuation suitable for the surroundings of the mobile station.

The scope of the invention also includes a mobile radio network with at least one mobile station and a plurality of base stations and with at least one base station control unit for the execution of the method according to the invention. The position of the mobile station can be more accurately determined in a mobile radio network of this kind than in mobile radio networks in which the distances are estimated with rigid propagation models or without filtering.

### BRIEF DESCRIPTION OF THE DRAWINGS

Further advantages of the invention will be apparent from the description and the drawing. The features referred to in the foregoing and those to be referred to in the following can be used, in accordance with the invention, either individually or jointly in any combinations. The illustrated and described embodiments should not be considered as definitive but rather are of an exemplary nature for the description of the invention.

The invention is illustrated in the drawing and will be explained in detail in the form of an exemplary embodiment. In the drawing:

FIG. 1a shows the schematic arrangement of a mobile radio network and a position determination of a mobile station before the adaptation of the fundamental attenuation and

FIG. 1b shows the schematic arrangement of a mobile radio network and a position determination of a mobile station after the adaptation of the fundamental attenuation.

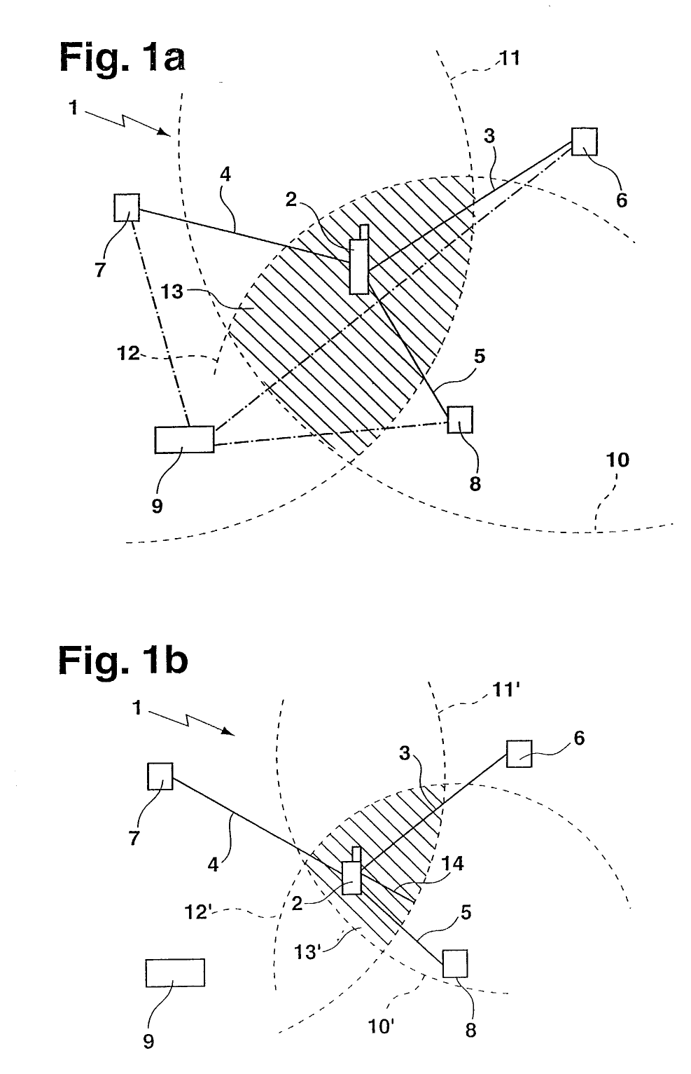

A part of a mobile radio network 1 is schematically illustrated in FIG. 1a. A mobile station 2 maintains a radio connection 3-5 to base stations 6-8 simultaneously or consecutively. For each base station 6-8, the field strength of the radio signals transmitted from each base station 6-8 is measured at the mobile station 2. The measured field strengths are transmitted to a base station control unit 9 in which the distance between the mobile station 2 and the respective base station 6-8 is estimated on the basis of a propagation model using predetermined propagation- and fundamental attenuation values.

The position of the mobile station 2 is determined by a trilateration. In the illustrated example a circular arc 10-12 whose radius corresponds to the particular estimated distance is placed around each base station 6-8. The shaded zone 13 determines the current location of the mobile station 2.

The mobile radio network 1 according to FIG. 1a is illustrated in FIG. 1b. In this case the distance between the mobile station 2 and each base station 6-8 was estimated using an adapted fundamental attenuation value of the propagation model. The fundamental attenuation value was adapted as a result of comparing the currently estimated distances with preceding distance estimations. The distance between the mobile station 2 and the base stations 6-8 can be more accurately estimated using the adapted fundamental attenuation factor. Here the circular arcs 10′-12′ have a smaller radius than the circular arcs 10-12 in FIG. 1a. The position of the mobile station 2 lies in the shaded zone 13′ which is smaller than the zone 13 in FIG. 1a. The position of the mobile station 2 therefore is more accurately determined in FIG. 1b. The difference, i.e. the shortest distance, between the estimated position of the mobile station 2 and the estimated distance 11′ has been referenced 14.

1. A method of estimating the position of a mobile station in a mobile radio network on the basis of propagation models, wherein at the mobile station the field strength of a plurality of base stations connected to the mobile station is measured, the distance between the mobile station and each of the base stations connected to the mobile station is estimated on the basis of a propagation model, and the estimated distances are stored, wherein the estimated distances are filtered and the position of the mobile station is estimated on the basis of the filtered estimated distances.

2. A method according to claim 1, wherein the estimated distances are filtered such that for each mobile station-base station connection, firstly the difference between the currently estimated distance and the last estimated distance is determined, a maximum difference is defined, and the position determination is effected using current estimated distances for which the difference is smaller than or equal to the maximum difference.

3. A method according to claim 1, wherein the estimated distances are filtered such that for each mobile station-base station connection, the estimated distances from a plurality of preceding measurements are averaged, the difference between the current estimated distance and the averaged estimated distance is determined, a maximum difference is defined, and the position determination is effected using current estimated distances for which the difference is smaller than or equal to the maximum difference.

4. A method according to claim 1 or 3, wherein the estimated distances of preceding measurements are temporally weighted.

5. A method according to claim 1, wherein an estimated position which lies outside a current cell is corrected by transposing the estimated position into the region of the cell.

6. A method according to claim 1, wherein the differences between the filtered estimated distances and the estimated position are determined and the fundamental attenuation in the propagation model is adapted on the basis of these differences.

7. A method according to claim 6, wherein the fundamental attenuation is self-adapted.

8. A method of estimating the position of a mobile station in a mobile radio network on the basis of propagation models, wherein at the mobile station the field strength of a plurality of base stations connected to the mobile station is measured, the distance between the mobile station and each of the base stations connected to the mobile station is estimated on the basis of a propagation model, and the estimated distances are stored, wherein the distances between the mobile station and the respective base stations are estimated using different values for the fundamental attenuation of the propagation model and the position of the mobile station is determined and stored for each value of the fundamental attenuation, that for each value of the fundamental attenuation the differences between the estimated positions and the estimated distances are determined, and the position which was determined using the smallest sum of the differences is selected.

9. A mobile radio network with at least one mobile station and with a plurality of base stations for the execution of a method of estimating the position of a mobile station in a mobile radio network on the basis of propagation models, wherein at the mobile station the field strength of a plurality of base stations connected to the mobile station is measured, the distance between the mobile station and each of the base stations connected to the mobile station is estimated on the basis of a propagation model, and the estimated distances are stored, wherein the estimated distances are filtered and the position of the mobile station is estimated on the basis of the filtered estimated distances.
